(19) United States
(12) Patent Application Publication
(10) Pub. No.: US 2014/0261084 A1
(43) Pub. Date: Sep. 18, 2014

(54) UV REFLECTING PIGMENTS, AND METHOD OF MAKING AND USING THE SAME

(71) Applicant: BASF SE, Ludwigshafen (DE)

(72) Inventors: Steven Jones, Budd Lake, NJ (US); Markus Rueckel, Mannheim (DE); Thomas Servay, Heidelberg (DE); Stefan Dahmen, Bad Durkheim (DE); Geoffrey Johnson, Wappingers Falls, NY (US)

(73) Assignee: BASF SE, Ludwigshafen (DE)

(21) Appl. No.: 14/206,147

(22) Filed: Mar. 12, 2014

Related U.S. Application Data
(60) Provisional application No. 61/793,518, filed on Mar. 15, 2013.
(60) Provisional application No. 61/902,992, filed on Dec. 16, 2013.

(51) Int. Cl. C08K 3/00

(52) U.S. Cl. CPC C08K 3/0033
USPC 106/417; 427/402; 427/255.28; 427/419.3; 427/419.2; 427/419.1; 427/164

(57) ABSTRACT

A pigment is disclosed wherein the pigment includes a platy substrate or uniform platy substrate coated with an odd number of layers of alternating layers of high or low refractive index material, wherein each layer has a refractive index that differs from adjacent layers by at least 0.2; and the pigment has from about 40 to about 100% reflectance of light having a wavelength of 280 nm to 400 nm. Processes for making and using the pigments are also disclosed. These pigments can find application in paints, plastics, cosmetics, glass, printing inks, and glazes.

This application takes the benefit of U.S. provisional application Nos. 61/793,518 and 61/902,992 filed on Mar. 15, 2013 and Nov. 12, 2013 respectively both herein incorporated entirely by reference.

### FIELD OF THE DISCLOSURE

The present disclosure relates to pigments that selectively reflect UV light, and methods of making and using the same.

### BACKGROUND

Interferences pigments are typically flake-form substrates that have been coated by multiple layers of metal oxides. Interference pigments are capable of exhibiting angle interference colors based on the reflection of light at the interface of layers of different refractive index. The color observed by the human eye (i.e., in the visible spectrum) of the interference pigment is based on the combination of layers having a different refractive index, the thickness of each layer of having a different refractive index, and the angle and wavelength of the light that irradiates the pigment. Interferences pigments are used in paints, coatings, plastics, printing inks, and cosmetics formulations.

There have been developed products, such as sun tan lotion, that use, e.g., organic molecules or inorganic nanoparticles, to absorb or scatter UV while allowing visible light to pass the product. However, organic molecules are not suitable for applications requiring long term protection. Inorganic nanoparticles can produce an undesirable haziness to a coating. Therefore, there is a need for another way to selectively reflect or absorb UV light when a long lasting transparent coating is desired for applications, such as an exterior wood coating or the protection of painting.

The present disclosure addresses this need by providing pigments that are capable of selectively reflecting UV light. The pigments of the present disclosure are suitable, for instance, for long term coatings.

### BRIEF SUMMARY

The following embodiments are not an extensive overview. The following embodiments are not intended to either identify critical elements of the various embodiments, nor is it intended to the limit the scope of them. Additional variations will be apparent to the skilled person.

In an embodiment, a pigment is disclosed which includes a platy substrate, wherein the platy substrate is transparent, has a low refractive index, and is coated with an odd number of layers of from 3 to 23 alternating layers of high or low refractive index material, wherein each layer has a refractive index that differs from adjacent layers by at least 0.2; wherein each layer of high refractive index material has a thickness of 10-40 nm; wherein each layer successively encapsulates the platy substrate and all previous layers such that each layer is applied equally to both sides of the platy substrate; each layer of low refractive index material has a thickness of 20-80 nm; and the pigment has from about 40 to about 100% reflectance of light having a wavelength of 280 nm to 400 nm, and from about 0 to 20% reflectance of light from 450 to 900 nm. In an embodiment of the pigment, the platy substrate comprises glass, aluminum oxide, natural mica, synthetic mica, talc, bismuth oxychloride, silica, natural pearl, boron nitride, silicon dioxide, zinc oxide, a natural silicate, a synthetic silicate, an aluminum silicate, or combinations thereof. In an embodiment of the pigment, the high refractive index material comprises at least one of TiO₂, strontium titanate, cubic zirconia, or zinc oxide; and the low refractive index material comprises at least one of SiO₂, Al₂O₃, or MgF₂. In an embodiment of the pigment, the high refractive index material comprises TiO₂ and each high refractive index layer has a thickness of 15-30 nm, the low refractive index material comprises SiO₂ and each low refractive index layer has a thickness of 20-60 nm, and the pigment has from about 70 to about 100% reflectance of light having a wavelength of 280 nm to 350 nm. In an embodiment, the pigment has a high refractive index layer in direct contact with the platy substrate, and a high refractive index layer as the outer most layer of the alternating layers of high and low refractive index material. In an embodiment, the pigment has 3, 5, 7, 9, 11, 13, 15, 17, 19, 21, or 23 layers of alternating layers of high and low refractive index materials coated onto the platy substrate.

In an embodiment, a pigment is disclosed which includes a uniform platy substrate, wherein the uniform platy substrate has a low refractive index and is coated with an odd number of optical layers of from 1 to 11 alternating layers of high and low refractive index material; wherein each optical layer has a refractive index that differs from adjacent layers by at least 0.2; wherein each layer successively encapsulates the uniform platy substrate and all previous layers such that each layer is applied equally to both sides of the platy substrate; wherein the thickness of the uniform platy substrate has an average from about 30 to 90 nm such that the uniform platy substrate functions as a central optical layer of the pigment; wherein the pigment has a total of 2n+1 optical layers; n is a total number of optical layers of high and low refractive index material coated onto the uniform platy substrate; each optical layer of high refractive index material has a thickness of 10-40 nm; each optical layer of low refractive index material has a thickness of 20-80 nm; and the pigment has from about 40 to about 100% reflectance of light having a wavelength of 280 nm to 400 nm, and from about 0 to 20% reflectance of light from 450 to 900 nm. In an embodiment of the pigment, the uniform platy substrate is a silicate. In an embodiment of the pigment, the high refractive index material comprises at least one of TiO₂, strontium titanate, cubic zirconia, or zinc oxide; and the low refractive index material comprises at least one of SiO₂, Al₂O₃, or MgF₂. In an embodiment of the pigment, the high refractive index material comprises TiO₂ and each high refractive index layer has a thickness of 15-30 nm, the low refractive index material comprises SiO₂ and each low refractive index layer has a thickness of 20-60 nm, and the pigment has from about 70 to about 100% reflectance of light having a wavelength of 280 nm to 350 nm. In an embodiment, the pigment has a high refractive index layer in direct contact with the uniform platy substrate, and a high refractive index layer as the outer most layer of the alternating layers of high and low index material. In an embodiment, the pigment has 1, 3, 5, 7, 9, or 11 layers of alternating layers of high and low refractive index materials coated onto the uniform platy substrate; and the thickness of the uniform platy substrate has an average from about 50 to about 70 nm.

In an embodiment, a method of making a pigment is disclosed which includes:

a first deposition step of depositing a first layer of high refractive index material onto a platy substrate to form a coated substrate, wherein the platy substrate is transparent and has a low refractive index;

a second deposition step of depositing a layer of low refractive index material onto the first layer of high refractive index material, and then depositing a second layer of high refractive index material onto the layer of low refractive index material to form the pigment, wherein each layer has a refractive index that differs from adjacent layers by at least 0.2; each layer of high refractive index material has a thickness of 10-40 nm; each layer of low refractive index material has a thickness of 20-80 nm; and the pigment has from about 40 to about 100% reflectance of light having a wavelength of 280 nm to 400 nm, and from about 0 to 20% reflectance of light from 450 to 900 nm. In an embodiment of the method, at least one of the first or second deposition step comprises a chemical vapor deposition (CVD), a physical vapor deposition (PVD), or a wet-chemical process; the high refractive index material comprises TiO₂, and each layer of high refractive index material has a thickness of 10-40 nm; and the low refractive index material comprises at least one of SiO₂, Al₂O₃, or MgF₂, and each layer of low refractive index material has a thickness of 20-80 nm. In an embodiment of the method, each deposition step is a wet-chemical deposition and the platy substrate is treated with SnCl₄ before depositing each high refractive index layer. In an embodiment of the method, the pigment has from about 70 to about 100% reflectance of light having a wavelength of 280 nm to 350 nm, the high refractive index material comprises TiO₂ and each layer of high refractive index material has a thickness of 15-30 nm, and the low refractive index material comprises SiO₂ and each layer of low refractive index material has a thickness of 20-60 nm.

In an embodiment, a method of making a pigment is disclosed which includes:

a first deposition step of depositing a first layer of high refractive index material onto a uniform platy substrate to form a first pigment, wherein the uniform platy substrate has a low refractive index; and, optionally,

a second deposition step of depositing a layer of low refractive index material onto the first layer of high refractive index material, and then depositing a second layer of high refractive index material onto the layer of low refractive index material to form a second pigment; wherein each layer has a refractive index that differs from adjacent layers by at least 0.2; the thickness of the uniform platy substrate has an average from about 30 to 90 nm such that uniform platy substrate functions as a central optical layer of an optical system; wherein the optical system has a total of 2n+1 optical layers; n is the number of alternating layers of high and low refractive index material; each layer of high refractive index material has a thickness of 10-40 nm; each layer of low refractive index material has a thickness of 20-80 nm; and wherein the pigment has from about 40 to about 100% reflectance of light having a wavelength of 280 nm to 400 nm, and from about 0 to 20% reflectance of light from 450 to 900 nm. In an embodiment of the method, wherein at least one of the first and second deposition step comprises a chemical vapor deposition (CVD), a physical vapor deposition (PVD), or a wet-chemical process; the high refractive index material comprises TiO₂, and each layer of high refractive index material has a thickness of 10-40 nm; and the low refractive index material comprises at least one of SiO₂, Al₂O₃, or MgF₂, and each layer of low refractive index material has a thickness of 20-80 nm. In an embodiment of the method, wherein each deposition step is a wet-chemical deposition and the uniform platy substrate is treated with SnCl₄ before depositing each high refractive index layer. In an embodiment of the method, the pigment has from about 70 to about 100% reflectance of light having a wavelength of 280 nm to 350 nm, the high refractive index material comprises TiO₂ and each layer of high refractive index material has a thickness of 15-30 nm, and the low refractive index material comprises SiO₂ and each layer of low refractive index material has a thickness of 20-60 nm. In an embodiment, a product is disclosed which includes a pigment as discussed above.

It is to be understood that both the foregoing general description and the following detailed description are exemplary and explanatory and are intended to provide further explanation of the disclosed compounds, compositions, and methods.

### BRIEF DESCRIPTION OF THE DRAWINGS

For the purpose of illustrating the embodiments disclosed therein, there are depicted in the drawings certain embodiments of a pigment or computer generated spectrums of an embodiment of a pigment. However, the products and related methods are not limited to the precise arrangements and instrumentalities of the embodiments depicted in the drawings.

FIG. 1 is a schematic depiction of a surface of an embodiment of a pigment of the present disclosure.

FIG. 2 is a schematic depiction of a cross section of an embodiment of a pigment of the present disclosure.

FIG. 3 is a computer generated model of a spectrum of a representative pigment of the present disclosure.

FIG. 4 is a computer generated model of a spectrum of a representative pigment of the present disclosure.

FIG. 5 is a computer generated model of a spectrum of a representative pigment of the present disclosure.

FIG. 6 is a computer generated model of a spectrum of a representative pigment of the present disclosure.

FIG. 7 is a spectrum of the pigment from Example 5.

FIG. 8 is a spectrum of the pigment from Example 6.

FIG. 9 is a spectrum of the pigment from Example 7.

FIG. 10 is a spectrum of the pigment from Example 8.

FIG. 11 is a spectrum of the pigment from Example 9.

FIG. 12 is a spectrum of the pigment from Example 10.

FIG. 13 is a spectrum of the pigment from Example 11.

FIG. 14 is a spectrum of the pigment from Example 12.

### DETAILED DESCRIPTION OF THE INVENTION

Embodiments as discussed herein relate to pigments, their manufacture, and their use. The pigments of the present disclosure selectively reflect UV light while transmitting visible light. The pigments can be used in products such as paints, plastics, cosmetics, glass, printing inks, and glazes. Moreover, the pigments can be used in wood coatings to provide a coating that reflects UV light, while allowing visible light to pass through the coating. This use is advantageous in preventing the harmful effects of UV light, while maintaining a normal appearance. For example, a wood coating comprising a pigment of the present disclosure would be capable of blocking the harmful effects of UV while transmitting visible light, thereby allowing for the beauty of the underlying wood to be seen without allowing for UV damage from sunlight. Accordingly, these pigments can find application in the coatings field, for example, as coatings for outdoor furniture.

### DEFINITIONS

As used herein, each of the following terms has the meaning associated with it in this section, unless otherwise explicitly stated.

The articles “a” and “an” are used herein to refer to one or more than one object of the article. By way of an example, “an element” means one or more than one element.

The term “about” will be understood by persons of ordinary skill in the art to depend on the context in which it is used. When used in the context of a number, the term “about” is meant to encompass variations from ±5% of the number. When used in the context of a range, the term “about” encompass variations from −5% of the lower limit to +5% of the upper limit.

The term “transparent” refers to a material or an object that can transmit from 85 to 100% of visible light.

The term “low refractive index”, unless otherwise noted, refers to a material having a refractive index lower than or less than 1.8.

The term “high refractive index”, unless otherwise noted, refers to a material having a refractive index of from 2.0-4.0, including from 2.0-3.0.

The term “UV light” means ultraviolet light, and unless otherwise noted, means the wavelength of electromagnetic radiation from 280-400 nm.

“Visible light” refers to any wavelength of electromagnetic radiation from about 450-780 nm, unless otherwise noted.

For easily adjustable measurements, such as temperature, pressure, and thickness, it is understood that any and all, whole or partial integers between any ranges set forth herein are included.

As envisioned in the present invention with respect to the disclosed compositions of matter and methods, in one aspect, the embodiments of the invention comprise the components and/or steps disclosed therein. In another aspect, the embodiments of the invention consist essentially of the components and/or steps disclosed therein. In yet another aspect, the embodiments of the invention consist of the components and/or steps disclosed therein.

### First Embodiments of a Pigment

In an embodiment of the pigment, the pigment includes a platy substrate, wherein the platy substrate has a low refractive index and is coated with an odd number of layers of from 3 to 23 alternating layers of high or low refractive index material, wherein each layer has a refractive index that differs from adjacent layers by at least 0.2. In an embodiment, the pigment has from about 40 to about 100% reflectance of light having a wavelength of 280 nm to 400 nm, and from about 0 to 20% reflectance of light from 450 to 900 nm. In an embodiment, the pigment has from about 70 to about 100% reflectance of light having a wavelength of 280 nm to 350 nm.

A “platy substrate” refers to a particle that has the form of a flake or chip, such that the particle has two surfaces, which are generally smooth and flat enough to reflect visible light and which can be but are not necessarily parallel to each other. Unless otherwise noted, a platy substrate is transparent. The dimensions of the platy substrate are not generally limited. The “thickness” of a platy substrate refers to the smallest dimension of the substrate particle. The “length” of the platy substrate refers to the longest dimension of a particle, and may also be referred to as the “diameter” of the particles. The “width” of the particle refers to the second longest dimension of the particle, regardless of angle relative to the thickness and length of the particle. The two substantially parallel surfaces are defined by the length and width of the particle. Due to the flake-form of a substrate, the thickness of the platy substrate can be perpendicular to the length and width of the platy substrate. Also due to the flake-form of the substrate, the thickness is less than the length and width of the platy substrate.

The length and width of the platy substrate are not generally limited. In some embodiments of the pigment, the length of the platy substrate can range from an average of about 5 to about 500 μm, from about 60 to about 200 μm, or from about 80-150 μm. If the length of the platy substrate extends above about 500 μm, then the effective coverage of the pigment in a coating can be reduced. If the length of the platy substrate extends below about 5 μm, then the optical effects of the pigment can be diminished.

The average thickness of the platy substrate can range from about 50 nm to about 5 μm, from about 50 nm to 500 nm, or from about 50 nm to about 200 nm. If the average thickness of the platy substrate extends above about 5 μm, then the effectiveness of the pigment in a coating can be reduced. A platy substrate of this nature will generally have a wide distribution of platelet to platelet thickness such that the optical contribution of the platy substrate is “averaged out” and only the optical layers coated onto the platy substrate provide the UV reflection.

The material of the substrate is not particularly limited so long as the material has a transparency of about 60% to 100%, and is sturdy enough to function as a stable support for metal oxide layers. In an embodiment, materials suitable for the platy substrate include glass, aluminum oxide, natural mica, synthetic mica, talc, bismuth oxychloride, silica, natural pearl, boron nitride, silicon dioxide, zinc oxide, a natural silicate, a synthetic silicate, an aluminum silicate, or combinations thereof. An advantage of mica as a platy substrate can be that mica is naturally flaky, inexpensive, and has flat, smooth surfaces. An advantage of glass as a platy substrate material can be that glass is transparent, inexpensive, and forms smooth surfaces for coating.

In an embodiment, a platy substrate can be directly coated by a metal oxide layer, such as TiO₂. In another embodiment, a platy substrate can be pre-treated with a rutile directing agent, such as SnCl₄, which deposits on the surface of the substrate and causes TiO₂ to form as rutile instead of anatase. For the purposes of the present disclosure, a rutile directing agent or the product thereof is not regarded as preventing direct contact between the platy substrate pre-treated with the rutile directing compound and the layer that is deposited. For example, a platy substrate can be treated with SnCl₄ before TiO₂ is deposited on the substrate. In that case, the TiO₂ layer is defined as being “in direct contact” with the platy substrate, because the rutile directing compound, or product thereof, is not regarded as forming a whole, continuous layer between the platy substrate and the TiO₂ layer. Also, the tin compounds deposited by the pre-treatment process are regarded as having no optical effect of their own.

In an embodiment, the platy substrate is coated with an odd number of layers of from 3 to 23 alternating layers of high and low refractive index material, wherein each layer has a refractive index that differs from adjacent layers by at least 0.2. In an embodiment, each layer successively encapsulates the platy substrate and all previous layers such that each layer is applied equally to both sides of the platy substrate.

In an embodiment, the layers of high refractive index material have a refractive index ranging from 2.0-4.0, from 2.0-3.0, or from 2.2-2.50. In an embodiment, the layers of high refractive index material each have a thickness from 10-40 nm, or from 15-30 nm. In an embodiment, materials suitable for the high refractive index material include TiO₂, strontium titanate, cubic zirconia, and zinc oxide. An advantage of using TiO₂ as the high refractive index material can be that TiO₂ has a very high refractive index (about 2.49 for the anatase form), high transparency, and is easy to process into stable layers. An advantage to using rutile TiO₂ can be the high refractive index (about 2.55) compared to anatase TiO₂. Unless otherwise indicated, all instances “TiO₂” refer to either the rutile or anatase form of TiO₂.

In an embodiment, the layers of low refractive index material have a refractive index that is at least 0.2 less than a high refractive index material the low refractive index materials is adjacent to. For example, a low refractive index material can have a refractive index of 1.3-1.8, or 1.3-1.6. In an embodiment, the layers of low refractive index material each have a thickness from 20-80 nm, or from 20-60 nm. In an embodiment, materials suitable for the low refractive index material include SiO₂, Al₂O₃, or MgF₂. An advantage of using SiO₂ as the low refractive index material can be that SiO₂ has a low refractive index (about 1.4 to 1.5), high transparency, and is easy to process into stable layers.

The thicknesses of the alternating layers of high and low refractive index material contribute to optical properties of the pigment. If the thicknesses of the alternating layers of high and low refractive index material is greater than the upper limits discussed above or lower than the lower limits discussed above, then the interference effects of the pigment may not selectively filter UV light and/or may block the transmission of visible light. It is understood that each of the alternating layers of high and low refractive index material functions as an optical layer in an optical system that can selectively reflect UV light and transmit visible light. In an embodiment, the platy substrate does not function as an optical center or an optical layer: instead it serves as support for the layers of high and low refractive index material, which are optical layers.

In an embodiment, the pigment has a high refractive index layer in direct contact with the platy substrate and a high refractive index layer as the outer most layer of the alternating layers of high and low refractive index material. Although it is possible to form a pigment having a low refractive layer in contact with the platy substrate and/or as the outermost layer, using a high refractive layer material in contact with the platy substrate and as an outermost layer can be advantageous, because it allows for higher reflectivity than if the outer layer is a low refractive index material.

Referring to FIG. 1, in an embodiment, a pigment 100 can include a platy substrate 102. A first high refractive index material layer 104 can be coated onto both sides, and directly in contact with the platy substrate 102. A low refractive index material layer 106 can be coated onto both sides, and directly in contact with the first high refractive index material layer 104. A second high refractive index material layer 108 can be coated onto both sides and directly in contact with the low refractive index material 106. The low refractive index material layer 106 has a refractive index at least 0.2 less than the refractive index for the first high refractive index material layer 104 and the second high refractive index material layer 108. In this embodiment, the first high refractive index material layer 104 is in direct contact with the platy substrate 102, and the second high refractive index material layer 108 is the outer most layer of the alternating layers of high (104, 108) and low (106) refractive index material.

### Second Embodiments of a Pigment

In another embodiment, the pigment can include a uniform platy substrate, wherein the uniform platy substrate has a low refractive index and is coated with an odd number of optical layers of from 1 to 11 alternating layers of high and low refractive index material, wherein each layer has a refractive index that differs from adjacent layers by at least 0.2. As used herein, a “uniform platy substrate” refers to a platy substrate, as defined elsewhere herein, that has a uniform thickness distribution. The substantially parallel planar surfaces of a uniform platy substrate are generally smooth and flat enough to transmit visible light. Unless otherwise noted, a uniform platy substrate is transparent.

In an embodiment, the thickness of the uniform platy substrate is from about 30 to 90 nm, or from about 50 to about 70 nm, such that the uniform platy substrate functions in the pigment as the central optical layer. According to this embodiment, the pigment has a total of 2n+1 optical layers, wherein “n” is a total number of optical layers of high and low refractive index material. In this way, the uniform platy substrate functions as both a support for the coating of additional layers and as a layer of low refractive index that functions as optical center of the pigment (optical system).

In an embodiment, the average thickness of the platy substrate can range from about 50 nm to about 5 μm, from about 50 nm to 500 nm, or from about 50 nm to about 200 nm.

The discussion elsewhere herein of dimensions of a platy substrate are also applicable to a uniform platy substrate. Accordingly, the dimensions of the uniform platy substrate are not generally limited, except for thickness. The “thickness” of a uniform platy substrate refers to the smallest dimension of a substrate particle. The “length” of the uniform platy substrate refers to the longest dimension of a particle, and may also be referred to as the “diameter” of the particles. The “width” of the particle refers to the second longest dimension of the particle, regardless of angle relative to the thickness and length of the particle. Due to the flake-form of the uniform platy substrate, the thickness is typically perpendicular to the length and width of the uniform platy substrate.

The length and width of the uniform platy substrate are not generally limited. In some embodiments of the pigment, the length of the uniform platy substrate can range from an average of about 5 to about 500 μm, from about 60 to about 200 μm, or from 80-150 μm. If the length of the uniform platy substrate extends above about 500 μm, then the transparency of the coating can be reduced. If the length of the uniform platy substrate extends below about 5 μam, then the optical effects of the pigment can be diminished.

The thickness of the uniform platy substrate when an optical core has an average from about 30 nm to about 90 nm, or from about 50 nm to about 70 nm. To be considered a uniform distribution, the thickness of the transparent platy substrate cannot differ for example by more than ±5 nm. If the thickness of the uniform platy substrate extends above about 90 nm, then the transparency of the pigment can be reduced. If the thickness of the uniform platy substrate extends below about 30 nm, then the pigment can have reduced optical effects. If the uniformity of the distribution exceeds ±5 nm of the average, then the uniform platy substrate cannot function as an optical center for the pigment (optical system).

The material of the uniform platy substrate is not particularly limited so long as the material has a transparency of about 60% to 100%, and is sturdy enough to function as a stable support for metal oxide layers. In an embodiment, materials suitable for the uniform platy substrate include silicates, such as silica, glass, phyllosilicates, and the like. An advantage of silica is that it is transparent, inexpensive, forms smooth surfaces for coating, and can be doped to increase or decrease the refractive index, if necessary.

In an embodiment, a uniform platy substrate can be directly coated by a metal oxide layer, such as TiO₂ or SiO₂. In another embodiment, a uniform platy substrate can be pre-treated with a rutile directing compound, such as SnCl₄, which deposits on the surface of the substrate and causes TiO₂ to form as rutile phase instead of anatase. For the purposes of the present disclosure, a rutile directing compound or the product thereof is not regarded as preventing direct contact between the uniform platy substrate pre-treated with the rutile directing compound and the layer that is deposited. For example, a uniform platy substrate can be treated with SnCl₄ before TiO₂ is deposited on the substrate. In that case, the TiO₂ layer is defined as being “in direct contact” with the uniform platy substrate, because the rutile directing compound is not regarded as forming a whole, continuous layer between the uniform platy substrate and the TiO₂ layer. Also, the tin compounds deposited by the pre-treatment process are regarded as having no optical effect.

In an embodiment, the uniform platy substrate is coated with 1 to 11 of alternating layers of high and low refractive index material, and each optical layer has a refractive index that differs from adjacent layers by at least 0.2. In an embodiment, each layer successively encapsulates the uniform platy substrate and all previous layers such that each optical layer is applied equally to both sides of the uniform platy substrate, and the uniform platy substrate functions as the optical center of the pigment (optical system).

In an embodiment, the layers of high refractive index material have a refractive index ranging from 2.0-4.0, from 2.0-3.0, or from 2.2-2.5. In an embodiment, the layers of high refractive index material each have a thickness from 10-40 nm, or from 15-30 nm. In an embodiment, materials suitable for the high refractive index material include TiO₂, strontium titanate, cubic zirconia, and zinc oxide. An advantage of using TiO₂ as the high refractive index material is that TiO₂ has a very high refractive index (about 2.49 for anatase), high transparency, and is easy to process into stable layers. An advantage to using rutile TiO₂ can be the high refractive index (about 2.55) compared to anatase TiO₂. Unless otherwise indicates, all instances “TiO₂” refers to either the rutile or anatase form of TiO₂.

In an embodiment, the layers of low refractive index material have a refractive index that is a least 0.2 less than a high refractive index material to which the low refractive index materials is adjacent. For example, a low refractive index material can have a refractive index of 1.3-1.8, or from 1.3-1.6. In an embodiment, the layers of low refractive index material each have a thickness from 20-80 nm, or from 20-60 nm. In an embodiment, materials suitable for the low refractive index material include SiO₂, Al₂O₃, or MgF₂. An advantage of using SiO₂ as the low refractive index material is that SiO₂ has a low refractive index (about 1.4-1.5), high transparency, and is easy to process into stable layers.

The thicknesses of the alternating layers of high and low refractive index material contribute to the optical properties of the pigment. If the thicknesses of the alternating layers of high and/or low refractive index material are greater than the upper limits discussed above or lower than the lower limits discussed above, then the interference effects of the pigment may not selectively filter UV light and/or may block the transmission of visible light. It is understood that each of the alternating layers of high and low refractive index material functions as an optical layer in an optical system capable of selectively reflecting UV light and transmitting visible light.

In an embodiment, the pigment has a high refractive index layer in direct contact with the transparent platy substrate, and a high refractive index layer as the outer most layer of the alternating layers of high and low refractive index material. Although it is possible to form a pigment having a low refractive layer in contact with the uniform platy substrate and as the outermost layer, using a high refractive layer material can be advantageous, because it allows for higher reflectivity than if the outer layer is a low refractive index material.

Referring to FIG. 2, in an embodiment, a pigment 200 can include a uniform platy substrate 202, which functions as a central optical layer. The high refractive index material layer 204 can be coated directly onto both sides of the uniform platy substrate 202 to form a pigment. In other embodiments, alternating layers of low and high refractive index material layers can be coated directly onto the high refractive index material layer 204 to form embodiments having n of 2-11 for a total of 2n+1 optical layers.

In an embodiment, a pigment can be subject to a surface treatment to enhance the weather and light stability of the pigments. Useful surface treatments are, for example, described in DE-A-2215191, DE-A-3151354, DE-A-3235017, DE-A-3334598, DE-A-4030727, EP-A-649886, WO97/29059, WO99/57204, and U.S. Pat. No. 5,759,255.

Pigment Manufacturing

In an embodiment, a method of making a pigment of the disclosure includes a first deposition step of depositing a first layer of high refractive index material onto a platy substrate to form a coated substrate, wherein the platy substrate is transparent and has a low refractive index; a second deposition step of depositing a layer of low refractive index material onto the first layer of high refractive index material, and then depositing a second layer of high refractive index material onto the layer of low refractive index material to form the pigment.

In an embodiment, a chemical vapor deposition (CVD), a physical vapor deposition (PVD), and/or a wet-chemical process known in the art can be used to deposit the first layer of high refractive index material, the layer of low refractive index material, and/or the second layer of high refractive index material. An advantage of using a physical or chemical vapor deposition step is precise control over thickness and purity of the layers deposited. An advantage of a wet-chemical can be lower costs and higher volumes of production.

In an embodiment, the platy substrate is pre-treated with a rutile directing agent, such as SnCl₄, before the addition of TiO₂, because this causes the TiO₂ to form rutile TiO₂ instead of anatase TiO₂. As discussed elsewhere herein, one benefit of using a rutile directing agent can be that rutile TiO₂ has a higher refractive index than anatase TiO₂.

In an embodiment, a method of making a pigment includes a first deposition step of depositing a first layer of high refractive index material onto a uniform platy substrate to form a pigment, wherein the uniform platy substrate has a low refractive index; and, optionally, a second deposition step of depositing a layer of low refractive index material onto the first layer of high refractive index material, and then depositing a second layer of high refractive index material onto the layer of low refractive index material to form a second pigment.

In an embodiment, a chemical vapor deposition (CVD), a physical vapor deposition (PVD), and/or a wet-chemical process known in the art can be used to deposit the first layer of high refractive index material, the layer of low refractive index material, and/or the second layer of high refractive index material. As mentioned above, an advantage of using a physical or chemical vapor deposition step is high control over thickness and purity of the layers deposited. An advantage of a wet-chemical can be lower costs and higher volumes of production.

In an embodiment, the uniform platy substrate is pre-treated with a rutile directing agent, such as SnCl₄, before the addition of TiO₂, because this causes the TiO₂ to form rutile TiO₂ instead of anatase TiO₂. One benefit of using a rutile directing agent can be that rutile TiO₂ has a higher refractive index than anatase TiO₂.

### EXPERIMENTAL

The following examples are set forth in order to further illustrate the invention but are not intended to limit it. Throughout this specification and claims, all parts and percentages are by weight and all temperatures and degrees are Centigrade unless otherwise indicated.

### Example 1

A UV reflecting interference effect material is designed using a thin film optics modeling program. The substrate is designed to be an optically active mica type substrate with a wide distribution of physical thickness. Three optical coatings are designed encapsulating the substrate and alternating from TiO₂ to SiO₂ to TiO₂ from substrate to outer layer. The physical thicknesses of the optical layers are designed to maximize the reflection in the UV region and minimize the reflection in the visible region. The final optical layers are 16.55 nm TiO₂, 59.34 nm SiO₂, and 22.55 nm TiO₂ from substrate to outer layer. The distribution of resulting reflection spectra is averaged to provide the final modeled UV reflection spectrum. The corresponding modeled spectrum is shown in FIG. 3.

### Example 2

A 5 layer UV reflector is designed in the same way as Example 1, except with 5 optical layers. The final optical layers are 15.88 nm TiO₂, 55.56 nm SiO₂, 36.26 nm TiO₂, 59.56 nm SiO₂, and 16.88 nm TiO₂. The corresponding modeled spectrum is shown in FIG. 4.

### Example 3

A 7 layer UV reflector is designed in the same way as Example 1, except with 7 optical layers. The final optical layers are 12.61 nm TiO₂, 63.69 nm SiO₂, 40.52 nm TiO₂, 29.59 nm SiO₂, 40.52 nm TiO₂, 71.62 nm SiO₂, and 16.88 nm TiO₂. The corresponding modeled spectrum is shown in FIG. 5.

### Example 4

### Optical Substrate

A three layer UV reflector effect material is designed without a typical non-uniform platy substrate. The SiO₂ substrate thus acts both as both a scaffold for a layer of TiO₂, encapsulating the SiO₂ substrate, and as an optical layer in the center of the pigment (e.g., the optical center). Light passing thought this UV reflector will encounter the alternating optical layers of TiO₂ and SiO₂ (optical center) and TiO₂. In this example, the final optical layers are 20 nm TiO₂, 60 nm SiO₂, and 20 nm TiO₂. The corresponding modeled spectrum is shown in FIG. 6.

### Example 5

A slurry of 130 g of mica (average particle size 20 microns) in 2000 mL of distilled H₂O was heated to 82° C. and the pH was adjusted to 1.5 with HCl. Then, 15 g of 20% SnCl₄.5H₂O are added at a rate of 1.0 g/min while maintaining the pH at 1.50 with NaOH. After 1 hr stirring, 60 g of 40% TiCl₄ were added at 2.0 g/min while maintaining the pH at 1.50 with NaOH. After the addition is complete, the pH is adjusted to 7.80 with NaOH, then 550 g of 20% Na₂SiO₃.5H₂O is added at 2.0 g/min while the pH is controlled at 7.80 with HCl. Next, the pH is lowered to 1.50 by adding HCl, followed by 28 g of 20% SnCl₄ added at a rate of 1.5 g/min while controlling the pH at 1.50 with NaOH. The slurry is stirred for 30 minutes then 90 g of 40% TiCl₄ is added at a rate of 2.0 g/min while maintaining the pH at 1.50 with NaOH. A 50 mL sample of the slurry is filtered, washed, and calcined at 850° C. for 20 min

The resulting pigment had λ max in reflection of 372 nm. The spectrum for Example 5 is shown in FIG. 7.

### Example 6

The pH of a slurry of 130 g of synthetic mica (average particle size 20 microns) in 2000 mL of distilled H₂O is adjusted to 1.4 HCl. Then, 7.3 g of 20% SnCl₄.5H₂O are added at a rate of 1.0 g/min while maintaining the pH at 1.40 with NaOH. After 30 min stirring, the slurry is heated to 74° C., and 67 g of 40% TiCl₄ were added at 2.0 g/min while maintaining the pH at 1.40 with NaOH. Upon completion, the slurry is heated to 82° C. and the pH is adjusted to 7.80 with NaOH. Then 605 g of 20% Na₂SiO₃.5H₂O are added at 2.0 g/min while the pH is controlled at 7.80 with HCl. Next, the pH is lowered to 1.50 by adding HCl, followed by 28 g of 20% SnCl₄ is added at a rate of 1.5 g/min while controlling the pH at 1.50 with NaOH. The slurry is stirred for 30 minutes, then 90 g of 40% TiCl₄ is added at a rate of 2.0 g/min while maintaining the pH at 1.50 with NaOH. A 50 mL sample of the slurry is filtered, washed, and calcined at 850° C. for 20 min.

The resulting pigment had λ max in reflection of 332 nm. The spectrum for Example 6 is shown in FIG. 8.

### Example 7

A slurry of 130 g of mica (average particle size 45 microns) in 2000 mL of distilled H₂O is heated to 82° C. and the pH was adjusted to 1.5 with HCl. Then, 30 g of 20% SnCl₄.5H₂O is added at a rate if 0.6 g/min while maintaining the pH at 1.40 with NaOH. After 1 hr stirring, 27 g of 40% TiCl₄ are added at 1.9 g/min while maintaining the pH at 1.40 with NaOH. Upon completion the temperature is lowered to 73° C. and the pH is adjusted to 7.80 with NaOH, then 248 g of 20% Na₂SiO₃.5H₂O at 2.0 g/min while the pH is controlled at 7.80 with HCl. Next, the slurry is heated to 82° C. and the pH is lowered to 1.80 with HCl followed by rapid addition of 10 g of 20% SnCl₄ without pH control. Next, the slurry is stirred for 30 minutes, then 75 g of 40% TiCl₄ are added at 0.7 g/min while maintaining the pH at 1.40 with NaOH. A 50 mL sample of the slurry is filtered, washed, and calcined at 850° C. for 20 min.

The resulting pigment had λ max in reflection of 350 nm. The spectrum for Example 7 is shown in FIG. 9.

### Example 8

A slurry of 130 g of synthetic mica (average particle size 30 microns) in 2000 mL of distilled H₂O is heated to 40° C. and the pH is adjusted to 1.4 with HCl. Then, 5.6 g of 20% SnCl₄.5H₂O are added at 0.5 g/min while maintaining the pH at 1.40 with NaOH. After 1 hr stirring, the slurry is heated to 70° C., then 42 g of 40% TiCl₄ are added at 1.0 g/min while maintaining the pH at 1.40 with NaOH. Upon completion, the pH is adjusted to 7.80 with NaOH, then 405 g of 20% Na₂SiO₃.5H₂O are added at 2.0 g/min while the pH is controlled at 7.80 with HCl. Next, the pH is lowered to 1.50 HCl followed by 28 g of 20% SnCl₄ added at 1.5 g/min while controlling the pH at 1.50 with NaOH. The slurry is stirred for 30 minutes, then 67 g of 40% TiCl₄ aqueous solution are added at 2.0 g/min while maintaining the pH at 1.50 with NaOH. A 50 mL sample of the slurry is filtered, washed, and calcined at 850° C. for 20 min.

The resulting pigment had λ max in reflection of 332 nm. The spectrum for Example 8 is shown in FIG. 10.

### Example 9

A slurry of 130 g of mica (average particle size 5 microns) in 2000 mL of distilled H₂O is heated to 74° C. and the pH is adjusted to 1.6 with HCl. Then, 18.2 g of 20% SnCl₄.5H₂O was added at a rate of 0.9 g/min while maintaining the pH at 1.60 with NaOH. After stirring for 30 min, 94 g of 40% TiCl₄ are added at 1.1 g/min while maintaining the pH at 1.60 with NaOH. The pH is then adjusted to 7.80 with NaOH and added 1081 g of 20% Na₂SiO₃.5H₂O at 1.0 g/min while the pH is controlled at 7.80 with HCl. Next, the pH is lowered to 1.60 with HCl and 20 g of 20% SnCl₄ are added at 0.9 g/min while controlling the pH at 1.60 with NaOH. The slurry is stirred for 30 minutes, then 80 g of 40% TiCl₄ aqueous solution is added at a rate of 1.1 g/min while maintaining the pH at 1.60 with NaOH. A 50 mL sample of the slurry is filtered, washed, and calcined at 850° C. for 20 min.

The resulting pigment had λ max in reflection of 336 nm. The spectrum for Example 9 is shown in FIG. 11.

### Example 10

The pH of a slurry of 130 g of synthetic mica (average particle size 12 microns) in 2000 mL of distilled H₂O is adjusted to 1.6 with HCl. Then, 26.4 of 20% SnCl₄.5H₂O is added at 1.1 g/min while maintaining the pH at 1.60 with NaOH. After stirring for 1 hr, the slurry is heated to 74° C. and 91.2 g of 40% TiCl₄ are added at 1.35 g/min while maintaining the pH at 1.60 with NaOH. The pH is then adjusted to 7.80 with NaOH and 824 g of 20% Na₂SiO₃.5H₂O are added at 2.0 g/min while the pH is controlled at 7.80 with HCl. Next, the pH is lowered to 1.60 with HCl, then 52 g of 20% SnCl₄ is added at a rate of 0.5 g/min while controlling the pH at 1.60 with NaOH. The slurry is stirred for 45 minutes then 90 g of 40% TiCl₄ aqueous solution are added at a rate of 1.35 g/min while maintaining the pH at 1.60 with NaOH. A 50 mL sample of the slurry is filtered, washed, and calcined at 850° C. for 20 min

The resulting pigment had λ max in reflection of 330 nm. The spectrum for Example 10 is shown in FIG. 12.

### Example 11

The pH of a slurry of 130 g of synthetic mica (average particle size 20 microns) in 2000 mL of distilled H₂O is adjusted to 1.4 with HCl. Then, 7.3 g of 20% SnCl₄.5H₂O is added at 1.0 g/min while maintaining the pH at 1.40 with NaOH. After stirring for 30 min, the slurry is heated to 74° C. and 64 g of 40% TiCl₄ are added at 2.0 g/min while maintaining the pH at 1.40 with NaOH. Upon completion, the slurry is heated to 82° C. and the pH is adjusted to 7.80 with NaOH, then 588 g of 20% Na₂SiO₃.5H₂O are added at 2.0 g/min while the pH is controlled at 7.80 with HCl. Next, the pH is lowered to 1.50 by adding HCl followed by 28 g of 20% SnCl₄ added at 1.5 g/min while controlling the pH at 1.50 with NaOH. The slurry is stirred for 30 minutes, then 130 g of 40% TiCl₄ aqueous solution are added at 2.0 g/min while controlling the pH at 1.50 with NaOH. Next, the pH is adjusted to 7.80 with NaOH and 605 g of 20% Na₂SiO₃.5H₂O are added at 2.0 g/min while the pH is controlled at 7.80 with HCl. Next, the pH is lowered to 1.50 with HCl followed by 28 g of 20% SnCl₄ added at 1.5 g/min while controlling the pH at 1.50 with NaOH. The slurry is stirred for 30 minutes, then 40 g of 40% TiCl₄ aqueous solution are added at 2.0 g/min while controlling the pH at 1.50 with NaOH. A 50 mL sample of the slurry is filtered, washed, and calcined at 850° C. for 20 min.

The resulting pigment had λ max in reflection of 350 nm. The spectrum for Example 11 is shown in FIG. 13.

### Example 12

A slurry of 130 g of mica (average particle size 5 microns) in 2000 mL of distilled H₂O is heated to 74° C. and the pH was adjusted to 1.6 with HCl. Then 18.2 g of 20% SnCl₄.5H₂O are added at a rate of 0.9 g/min while maintaining the pH at 1.60 with NaOH. After stirring for 30 min, 94 g of 40% TiCl₄ are added at a rate of 1.1 g/min while maintaining the pH at 1.60 with NaOH. The pH is then adjusted to 7.80 with NaOH and 861.5 g of 20% Na₂SiO₃.5H₂O are added at 1.0 g/min while the pH is controlled at 7.80 with HCl. Next, the pH is lowered to 1.60 with HCl and 20 g of 20% SnCl₄ is added at a rate of 0.9 g/min while controlling the pH at 1.60 with NaOH. After stirring for 30 minutes, 190 g of 40% TiCl₄ aqueous solution is added at a rate of 1.1 g/min while maintaining the pH at 1.60 with NaOH. The pH is then adjusted to 7.80 with NaOH and 886.4 g of 20% Na₂SiO₃.5H₂O are added at 1.0 g/min while the pH is controlled at 7.80 with HCl. Next, the pH is lowered to 1.60 with HCl followed by 20 g of 20% SnCl₄ added at 0.9 g/min while controlling the pH at 1.60 with NaOH. The slurry is stirred for 30 minutes, then 40 g of 40% TiCl₄ aqueous solution are added at 1.1 g/min while controlling the pH at 1.60 with NaOH. A 50 mL sample of the slurry is filtered, washed, and calcined at 850° C. for 20 min.

The resulting pigment had λ max in reflection of 362 nm. The spectrum for Example 12 is shown in FIG. 14.

The disclosures of each and every patent, patent application, and publication cited herein are hereby incorporated herein by reference in their entirety. One skilled in the art will readily appreciate that the present invention is well adapted to carry out the objects and obtain the ends and advantages mentioned, as well as those inherent therein. While the invention has been disclosed with reference to specific embodiments, it is apparent that other embodiments and variations of this invention may be devised by others skilled in the art without departing from the true spirit and scope used in the practice of the invention. The appended claims are intended to be construed to include all such embodiments and equivalent variations.

What is claimed is:

1. A pigment, comprising:
a platy substrate, wherein the platy substrate is transparent, has a low refractive index, and is coated with an odd number of layers of from 3 to 23 alternating layers of high or low refractive index material, wherein each layer has a refractive index that differs from adjacent layers by at least 0.2;
wherein each layer of high refractive index material has a thickness of 10-40 nm;
wherein each layer successively encapsulates the platy substrate and all previous layers such that each layer is applied equally to both sides of the platy substrate;
each layer of low refractive index material has a thickness of 20-80 nm; and
the pigment has from about 40 to about 100% reflectance of light having a wavelength of 280 nm to 400 nm, and from about 0 to 20% reflectance of light from 450 to 900 nm.

2. The pigment of claim 1, wherein the platy substrate comprises glass, aluminum oxide, natural mica, synthetic mica, talc, bismuth oxychloride, silica, natural pearl, boron nitride, silicon dioxide, zinc oxide, a natural silicate, a synthetic silicate, an aluminum silicate, or combinations thereof.

3. The pigment of claim 1, wherein the high refractive index material comprises at least one of TiO₂, strontium titanate, cubic zirconia, or zinc oxide; and
the low refractive index material comprises at least one of SiO₂, Al₂O₃, or MgF₂.

4. The pigment of claim 1, wherein the high refractive index material comprises TiO₂ and each high refractive index layer has a thickness of 15-30 nm,
the low refractive index material comprises SiO₂ and each low refractive index layer has a thickness of 20-60 nm, and
the pigment has from about 70 to about 100% reflectance of light having a wavelength of 280 nm to 350 nm.

5. The pigment of claim 1, wherein the pigment has a high refractive index layer in direct contact with the platy substrate, and a high refractive index layer as the outer most layer of the alternating layers of high and low refractive index material.

6. The pigment of claim 5, wherein the pigment has 3, 5, 7, 9, 11, 13, 15, 17, 19, 21, or 23 layers of alternating layers of high and low refractive index materials coated onto the platy substrate.

7. A pigment comprising:
a uniform platy substrate, wherein the uniform platy substrate has a low refractive index and is coated with an odd number of optical layers of from 1 to 11 alternating layers of high and low refractive index material;
wherein each optical layer has a refractive index that differs from adjacent layers by at least 0.2;
wherein each layer successively encapsulates the uniform platy substrate and all previous layers such that each layer is applied equally to both sides of the platy substrate;
wherein the thickness of the uniform platy substrate has an average from about 30 to 90 nm such that the uniform platy substrate functions as a central optical layer of the pigment;
wherein the pigment has a total of 2n+1 optical layers;
n is a total number of optical layers of high and low refractive index material coated onto the uniform platy substrate;
each optical layer of high refractive index material has a thickness of 10-40 nm;
each optical layer of low refractive index material has a thickness of 20-80 nm; and
the pigment has from about 40 to about 100% reflectance of light having a wavelength of 280 nm to 400 nm, and from about 0 to 20% reflectance of light from 450 to 900 nm.

8. The pigment of claim 7, wherein the uniform platy substrate is a silicate.

9. The pigment of claim 7, wherein the high refractive index material comprises at least one of TiO₂, strontium titanate, cubic zirconia, or zinc oxide; and
the low refractive index material comprises at least one of SiO₂, Al₂O₃, or MgF₂.

10. The pigment of claim 7, wherein the high refractive index material comprises TiO₂ and each high refractive index layer has a thickness of 15-30 nm,
the low refractive index material comprises SiO₂ and each low refractive index layer has a thickness of 20-60 nm, and
the pigment has from about 70 to about 100% reflectance of light having a wavelength of 280 nm to 350 nm.

11. The pigment of claim 7, wherein the pigment has a high refractive index layer in direct contact with the uniform platy substrate, and a high refractive index layer as the outer most layer of the alternating layers of high and low index material.

12. The pigment of claim 11, wherein the pigment has 1, 3, 5, 7, 9, or 11 layers of alternating layers of high and low refractive index materials coated onto the uniform platy substrate; and
the thickness of the uniform platy substrate has an average from about 50 to about 70 nm.

13. A method of making a pigment comprising:
a first deposition step of depositing a first layer of high refractive index material onto a platy substrate to form a coated substrate, wherein the platy substrate is transparent and has a low refractive index;
a second deposition step of depositing a layer of low refractive index material onto the first layer of high refractive index material, and then depositing a second layer of high refractive index material onto the layer of low refractive index material to form the pigment,
wherein each layer has a refractive index that differs from adjacent layers by at least 0.2;
each layer of high refractive index material has a thickness of 10-40 nm;
each layer of low refractive index material has a thickness of 20-80 nm; and
the pigment has from about 40 to about 100% reflectance of light having a wavelength of 280 nm to 400 nm, and from about 0 to 20% reflectance of light from 450 to 900 nm.

14. The method of claim 13, wherein at least one of the first or second deposition step comprises a chemical vapor deposition (CVD), a physical vapor deposition (PVD), or a wet-chemical process;
the high refractive index material comprises TiO₂, and each layer of high refractive index material has a thickness of 10-40 nm; and
the low refractive index material comprises at least one of SiO₂, Al₂O₃, or MgF₂, and each layer of low refractive index material has a thickness of 20-80 nm.

15. The method of claim 13, wherein each deposition step is a wet-chemical deposition and the platy substrate is treated with SnCl₄ before depositing each high refractive index layer.

16. The method of claim 13, the pigment has from about 70 to about 100% reflectance of light having a wavelength of 280 nm to 350 nm,
the high refractive index material comprises TiO₂ and each layer of high refractive index material has a thickness of 15-30 nm, and
the low refractive index material comprises SiO₂ and each layer of low refractive index material has a thickness of 20-60 nm.

17. A method of making a pigment according to claim 7 comprising:
a first deposition step of depositing a first layer of high refractive index material onto a uniform platy substrate to form a first pigment, wherein the uniform platy substrate has a low refractive index; and, optionally,
a second deposition step of depositing a layer of low refractive index material onto the first layer of high refractive index material, and then depositing a second layer of high refractive index material onto the layer of low refractive index material to form a second pigment;
wherein each layer has a refractive index that differs from adjacent layers by at least 0.2;
the thickness of the uniform platy substrate has an average from about 30 to 90 nm such that uniform platy substrate functions as a central optical layer of an optical system;
wherein the optical system has a total of 2n+1 optical layers;
n is the number of alternating layers of high and low refractive index material;
each layer of high refractive index material has a thickness of 10-40 nm;
each layer of low refractive index material has a thickness of 20-80 nm; and
wherein the pigment has from about 40 to about 100% reflectance of light having a wavelength of 280 nm to 400 nm, and from about 0 to 20% reflectance of light from 450 to 900 nm.

18. The method of claim 17, wherein at least one of the first and second deposition step comprises a chemical vapor deposition (CVD), a physical vapor deposition (PVD), or a wet-chemical process;
the high refractive index material comprises TiO₂, and each layer of high refractive index material has a thickness of 10-40 nm; and
the low refractive index material comprises at least one of SiO₂, Al₂O₃, or MgF₂, and each layer of low refractive index material has a thickness of 20-80 nm.

19. The method of claim 17, wherein each deposition step is a wet-chemical deposition and the uniform platy substrate is treated with SnCl₄ before depositing each high refractive index layer.

20. The method of claim 17, the pigment has from about 70 to about 100% reflectance of light having a wavelength of 280 nm to 350 nm,
the high refractive index material comprises TiO₂ and each layer of high refractive index material has a thickness of 15-30 nm, and
the low refractive index material comprises SiO₂ and each layer of low refractive index material has a thickness of 20-60 nm.

21. A product comprising the pigment of claim 1.

22. A product comprising the pigment of claim 7.

23. The product according to claim 21, wherein the product is selected from the group consisting of a paint, plastic, cosmetic, glass, printing inks, and glazes.
